(19) United States
(12) Patent Application Publication
(10) Pub. No.: US 2019/0163371 A1
(43) Pub. Date: May 30, 2019

(54) NEXT GENERATION STORAGE CONTROLLER IN HYBRID ENVIRONMENTS

(71) Applicant: Cisco Technology, Inc., San Jose, CA (US)

(72) Inventors: Raghunath Othayoth Nambiar, San Ramon, CA (US); Karthik Krishna Kulkarni, Fremont, CA (US); Rajesh Shroff, Dublin, CA (US); Manankumar Trivedi, Union City, CA (US)

(21) Appl. No.: 15/826,801

(22) Filed: Nov. 30, 2017

(51) Int. Cl. G06F 3/06

(52) U.S. Cl. CPC G06F 3/065; G06F 3/067; G06F 3/0659; G06F 3/0604

(57) ABSTRACT

A system can manage storage and access of data blocks in a hybrid environment. In one example, a system can identify a plurality of data block replicas distributed across sites, the plurality of data block replicas corresponding to respective blocks of data. The system can monitor events associated with the plurality of data block replicas and, based on the events, generate respective status and access data for the plurality of data block replicas. Based on the respective status and access data, the system can determine that one or more data block replicas associated with a block of data have reached a threshold. In response to the one or more data block replicas reaching the threshold, the system can modify a replica distribution across the sites for the block of data.

### TECHNICAL FIELD

The subject matter of this disclosure relates in general to the field of network storage and data access.

### BACKGROUND

Distributed computing environments have quickly gained popularity in both commercial and individual applications, due at least in part to their ability to scale and handle large streams of data. As big data computing applications continue to flourish, users and organizations are increasingly reliant on distributed computing environments, which are particularly suitable for big data computing applications. A number of cloud and distributed computing strategies have been developed to support the growing demands of big data. For example, cloud deployment architectures have employed data replication for data backup and access. Data replication can boost performance by increasing access to data. However, current data replication and cloud deployment strategies are rudimentary and largely static, generally lacking the flexibility to accommodate increasingly granular and diverse application requirements and often unable to adapt to network conditions. The lack of flexibility and granularity of current data replication and cloud deployment strategies can significantly hinder storage utilization and data access performance, particularly in big data computing applications.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a diagram of an example network environment for distributed data storage, access, and management;

FIG. 2A illustrates a diagram of an example scheme for splitting a file into blocks and generating replicas for distributed storage;

FIG. 2B illustrates a diagram of example metrics collected and maintained for the replicas illustrated in FIG. 2A;

FIG. 3 illustrates an example flow of replica management and orchestration operations in a network environment;

FIG. 4 illustrates a flowchart of an example method for replica storage and access management;

FIG. 5 illustrates an example architecture of a computing system; and

FIG. 6 illustrates an example network device.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

Disclosed are systems, methods, and computer-readable storage media for managing storage and access of data blocks in a hybrid environment. Data, such as a file, can be split into blocks, which can be distributed across various sites over one or more networks. Each block can include a plurality of data block replicas distributed across the various sites for improved data access performance and stability. A system, such as a storage controller, can manage the number and distribution (e.g., placement) of data block replicas for each block, as well as access to specific data block replicas for a requested block.

For example, the system can identify a plurality of data block replicas distributed across a local network and a remote network. The plurality of data block replicas can correspond to a block of data, such as a file chunk. The plurality of data block replicas can be stored across the local and remote networks along with data block replicas corresponding to other blocks of a data content item, such as other chunks or blocks of a file. The data content item (e.g., file) can thus be stored across the local and remote networks and accessed via a number of specific data block replicas which together make up the entire data content item.

The system can monitor events associated with the plurality of data block replicas, such as data access events, data transmission events, data provisioning events, data storage events, etc. Based on the events, the system can generate respective status and access data for the plurality of data block replicas. The respective status and access data can include, for example, data access statistics, data performance statistics, resource (e.g., network, storage, etc.) statistics, data storage characteristics, data access requests, data access requirements, data access priorities, data access patterns, data status information, resource status information, etc.

Based on the respective status and access data, the system can determine that one or more data block replicas corresponding to the block of data have reached one or more data access thresholds. The one or more data access thresholds can be based on, for example, a data block access count, a number or type of applications that have accessed the one or more data block replicas, a number of data block access requests associated with a job priority, an access pattern (e.g., IOPS, sequential access counts, random access counts, read access counts, write access counts, etc.), a data access performance (e.g., data access latency, network latency, etc.), a data block replica availability, a storage resource capacity, etc.

In response to the one or more data block replicas reaching the one or more data access thresholds, the system can modify a distribution across the sites of replicas corresponding to the block of data. The distribution of replicas can include the number and/or placement of replicas corresponding to the block of data. Thus, the one or more data access thresholds can trigger the system to modify the number and/or placement of replicas corresponding to the block of data. For example, the system can deploy new replicas, disable (e.g., withdraw, delete, etc.) existing replicas, move replicas from one site or resource to another, etc., thereby increasing/decreasing the number of replicas and modifying the distribution of replicas for the block of data.

When deploying or moving a replica, the system can identify a specific location or placement for the replica based on access patterns and/or requirements associated with the block of data corresponding to the replica. For example, the system can identify the storage resources available across the sites, determine the network conditions (e.g., network latency, throughput, congestion, etc.) and storage resource characteristics (e.g., storage type, storage capacity, storage throughput, IOPS, etc.) associated with the storage resources, and select a specific site and storage resource for the replica based on the access patterns and/or requirements associated with the block of data corresponding to the replica.

The system can also route data block access requests from applications to specific data block replicas across the sites. When routing a data block access request, the system can select a specific replica associated with the requested data block based on one or more factors, such as an application or job priority associated with the request, respective status and access data generated for the replicas of the requested data block (e.g., latency statistics, performance statistics, access patterns, application statistics, etc.), etc. The system can then route the request to the selected replica or provide the replica to the requesting application.

### Description

The disclosed technology addresses the need in the art for flexible, efficient, and granular data replication and management strategies. The present technology involves systems, methods, and computer-readable media for managing storage and access of data blocks in a hybrid environment. A hybrid environment can be used to implement distributed storage across different sites resources within one or more specific sites. Data stored in the hybrid environment can be split into smaller blocks (or chunks) and the smaller blocks stored across different storage components or sites for increased performance.

In addition, data blocks can be replicated across sites as part of a data management and disaster recovery strategy. An orchestrator system, such as a controller, can manage the processing of data across sites, including storage, access and backups. The orchestrator system can make dynamic orchestration decisions and account for changing network conditions as well as specific application requirements.

Specific application requirements can have a significant impact on the network's ability to meet data demands. For example, applications can have varied data access requirements, including latency, bandwidth, or IOPS (input/output operations per second) requirements and sensitivities. Some applications can also have specific architecture requirements. For example, big data may require data locality for better IO bandwidth leading to more symmetric architectures with computing and storage co-located, while other applications may have greater compute requirements making them suitable for more asymmetric architectures with separation of computing and storage. Each of these factors can impact data access and storage performance.

Accordingly, to optimize data replication and access, the orchestrator system can intelligently account for these and other factors. For example, the orchestrator system can store data block replicas across different sites and storage resources based on specific application requirements, network conditions, storage availability, resource performance, etc. The orchestrator system can monitor every block of data across different sites and storage resources and collect relevant metrics.

Non-limiting examples of collected metrics include an access count of a block (e.g., how many times the block was accessed by one or more applications), which applications accessed the block, what priorities or requirements were associated with the applications that accessed the block, access patterns (e.g., IOPs, sequential access counts, random access counts, read access counts, write access counts, etc.), architecture patterns (e.g., data locality, compute and storage separate, etc.), network and IO latencies, etc. The orchestrator system can intelligently adjust the distribution of replicas based on the collected metrics by adding replicas, deleting replicas, moving replicas, etc.

The orchestrator system can also manage access to data blocks by routing jobs or requests to specific replicas of those blocks selected by the orchestrator system from the hybrid environment. The orchestrator system can select replicas for one or more blocks for a job or request based on one or more factors such as, for example, job priorities, latency requirements, IO throughput and requirements (e.g., sequential read or write, random read or write, etc.), architecture type (e.g., symmetric architecture, asymmetric architecture, etc.), and so forth. This intelligent, dynamic, and tailored access and management of data can lead to better utilization of resources across sites and increased performance.

As used herein, the term “site” refers to a composition of one or more networks (physical, logical, and/or virtual) and/or one or more resources (e.g., one or more storage resources, one or more compute resources, one or more network resources, etc.). While a site can include a physical area or location, such as a building or campus, it is not so required. For example, a site can be a physical and/or virtual area or location where one or more networks and/or one or more resources are located.

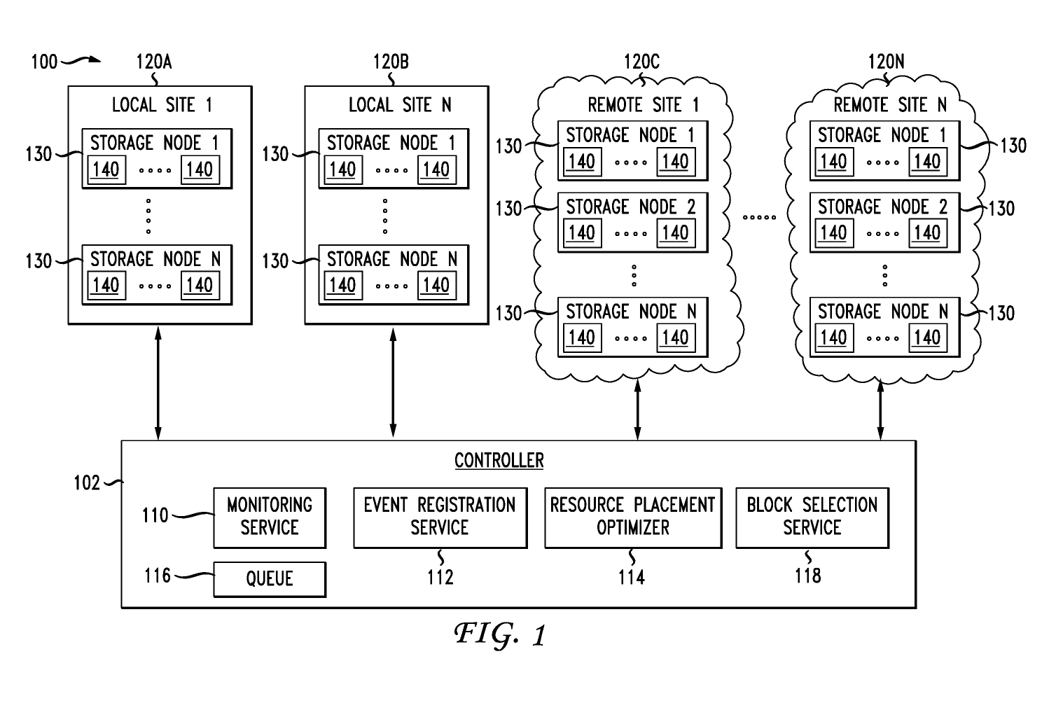

FIG. 1 illustrates a diagram of an example network environment 100 for distributed data storage, access, and management. The network environment 100 can include multiple sites 120A, 120B, 120C, 120N (collectively “sites 120” hereinafter) for hosting data. The sites 120 can include one or more local networks (e.g., branch networks, on-premises networks, etc.), one or more remote networks (e.g., clouds), one or more resources, etc. In some examples, the sites 120 can represent physical sites, logical sites, geographic areas, logical networks, etc. For example, sites 120A, 120B can represent local networks or infrastructure, and sites 120C, 120N can represent remote networks or infrastructure such as remote data centers and/or cloud networks.

The sites 120 can each include storage nodes 130 for storing data 140. The storage nodes 130 can include storage resources or infrastructure (physical and/or logical), such as storage devices (e.g., disks, volumes, drives, memory devices, storage hardware, storage networks, etc.). The storage nodes 130 can include one or more types of storage, such as HDDs (hard disk drives), SSDs (solid state drives), NAS (network attached storage), flash storage, optical drives, volatile memory, non-volatile memory, and/or any other type of storage. The storage nodes 130 can also have various types of configurations and storage interfaces, such as Fibre Channel, iSCSI or AoE (ATA over Ethernet), SATA, IEEE 1394, NVMe, IDE/ADA, etc. Accordingly, the storage nodes 130 can have different performance characteristics, such as storage capacity, latency, throughput, granularity (e.g., data sizes, etc.), reliability, IOPS (e.g., total IOPS, random read IOPS, random write IOPS, sequential read IOPS, sequential write IOPS, etc.), and so forth. The performance characteristics of the storage nodes 130 can be taken into account when making data replication, storage, and access decisions, as further described herein.

The storage nodes 130 can store data 140 for access by users, applications, devices, etc. The data 140 can represent digital content such as files, objects, blocks, raw data, metadata, etc. In this example, the data 140 includes blocks of data. The blocks can be a sequence of bytes or bits of a particular length or block size. Individual blocks can represent a portion of a larger block of data, such as a file. For example, a file can be split into blocks which together can be used to reconstruct the file. The blocks themselves can be files, records, volumes, logical partitions, etc., in storage. Moreover, the blocks can include replicas. For example, multiple replicas can be generated for a block and stored across different storage nodes 130 and/or sites 120.

Blocks can be abstracted by a namespace, file system and/or database for use by applications, devices, and end users. In some cases, the data 140 can include blocks of data as well as metadata about the blocks of data, which can be used to manage storage and access for blocks. For example, the storage nodes 130 can store blocks of data and maintain metadata about the blocks which can be used to store, manage, and access the blocks. The metadata for a block can include, for example, a location or address in storage and block attributes such as permissions, modifications, access times, namespace and disk space quotas, size, filename, directory organization, replicas, etc. The metadata of a block can be stored in a same or different location (e.g., storage node 130 and/or site 120). In some cases, the metadata of a block can be stored on a different storage node 130 or site 120 as the actual block. Moreover, one or more storage nodes 130 can maintain information about the various blocks on the network environment 100, such as a list of blocks, a location/address of each block, etc.

The network environment 100 can include a controller 102. The controller 102 can be one or more devices (physical and/or virtual) configured to orchestrate the storage and access of the data 140. The controller 102 can add, delete, and move data block replicas on the storage nodes 130, thereby controlling the placement, distribution, utilization, and number of data block replicas in the network environment 100. The controller 102 can also orchestrate access to specific data block replicas in the data 140 by selecting specific data block replicas for a requested block of data.

The controller 102 can monitor the sites 120, storage nodes 130, data 140, and data requests (e.g., jobs or application requests), and collect statistics and status information for replica and access orchestration. For example, the controller 102 can monitor the sites 120, storage nodes 130, data 140, and jobs, and maintain a heat map with thresholds to take actions (e.g., replica access, replica add, replica delete, replica move, etc.).

In some cases, the controller 102 can maintain a heat map for each block for metrics indicating how many times the block was accessed, which application(s) accessed the block, access pattern information (e.g., TOPS, sequential and/or random access patterns, read and/or write access patterns, etc.), latency (e.g., network latency, TO latency, etc.) of the application(s) accessing the block, etc. When a request for a block is received, the controller 102 can use the heat map of the blocks to select a replica of the requested block from the network environment 100. For example, the controller 102 can analyze the heat map of one or more blocks and select a replica based on one or more factors, such as an SLA (service level agreement) or job priority, a latency (e.g., within tolerable limits), an architecture type (e.g., symmetric or asymmetric), a current load, one or more access patterns, and availability, etc.

The controller 102 can make block orchestration decisions based on the heat map of one or more blocks and/or the access pattern data collected by the controller 102. For example, the controller 102 can intelligently add, remove, move, etc., one or more replicas in the network environment 100 based on the heat maps of blocks in the network environment 100. The controller 102 can add a replica to a specific site (e.g., the cloud or an on-premises site), add a replica to a specific storage node or type of storage (e.g., HDD, SDD, flash, etc.), remove a replica from a specific site (e.g., the cloud or an on-premises site), remove a replica from a specific storage node or a specific type of storage (e.g., HDD, SDD, flash, etc.), move a replica from one location to another (e.g., from one site and/or storage node to another), etc.

For example, the controller 102 can add a replica to local site 120A to increase local replica availability, delete a replica from local site 120B to reduce storage use or cost, move a replica from remote site 120C to local site 120B to increase locality, move a replica from remote site 120N to remote site 120C to avoid an increase in network congestion, add a replica to remote site 120N based on access patterns, etc.

The controller 102 can include a monitoring service 110 to monitor the sites 120, storage nodes 130, and data 140. The monitoring service 110 can monitor replicas for each block of data in the network environment 100, as previously explained. The controller 102 can include an event registration service 112 to register each event detected on the network environment 100 and generate metrics for the events, such as access patterns or statistics, status information, etc. The events can include, for example, jobs or requests received, data block access, data block provisioning, storage events, network events, errors, etc.

The controller 102 can also include a resource placement optimizer 114. The resource placement optimizer 114 can make data block placement and/or access decisions, as previously described, based on the information obtained by the monitoring service 110 and the event registration service 112. For example, the resource placement optimizer 114 can add, delete, and/or move one or more replicas based on access patterns, status information, heat maps, etc. This way, the resource placement optimizer 114 can adjust the number and distribution of replicas on the network environment 100 to optimize utilization and access.

The controller 102 can include a queue 116 for incoming jobs or requests for data 140. The queue 116 can identify each pending request for data 140 received in the network environment 100. The queue 116 can also include information about each pending request, such as a status, a timestamp, an order or place in the queue 116, a requesting application and/or device, one or more job or application requirements (e.g., a priority, latency limits, performance requirements, locality requirements, etc.), a log, the data requested (e.g., a file requested, the blocks of the file requested, the location of replicas of the blocks of the file, etc.), and/or any other metadata.

The controller 102 can also include a block selection service 118 that handles requests in the queue 116. The block selection service 118 can manage access to the data 140 for each request. For example, the block selection service 118 can identify the blocks requested by a request in the queue 116, and select replicas of the blocks for the request. The block selection service 118 can select the replicas based on metrics and information obtained by the monitoring service 110 and the event registration service 112, such as access patterns, status information, network conditions, etc. In some cases, the block selection service 118 can select the replicas based on heat maps as previously explained. The block selection service 118 can select the replicas based on the application Job priority and requirements (SLA, architecture type, etc.). Once the block selection service 118 identifies the replicas for a request, it can direct access to the replicas for the request. For example, the block selection service 118 can provide a response to the request and/or route the request based on the replicas selected. The response can identify or locate the selected replicas for the request, route or redirect the request to the selected replicas, or even provision the selected replicas for the request.

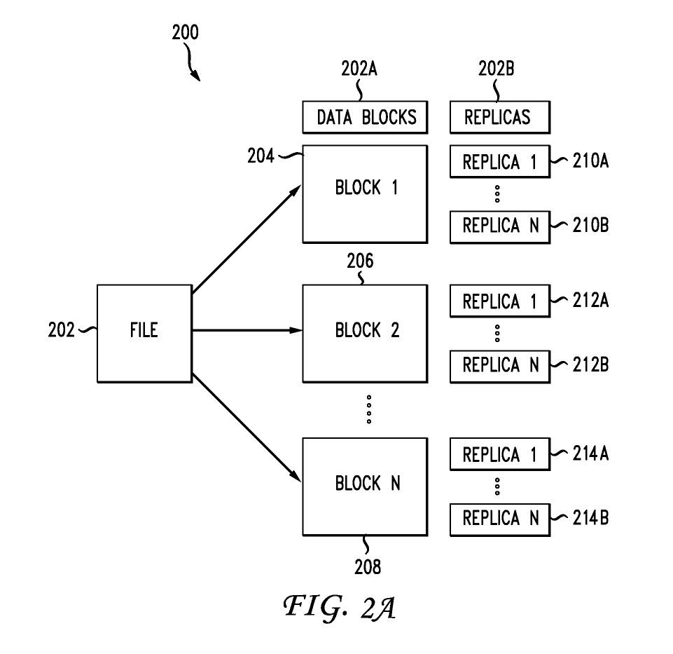

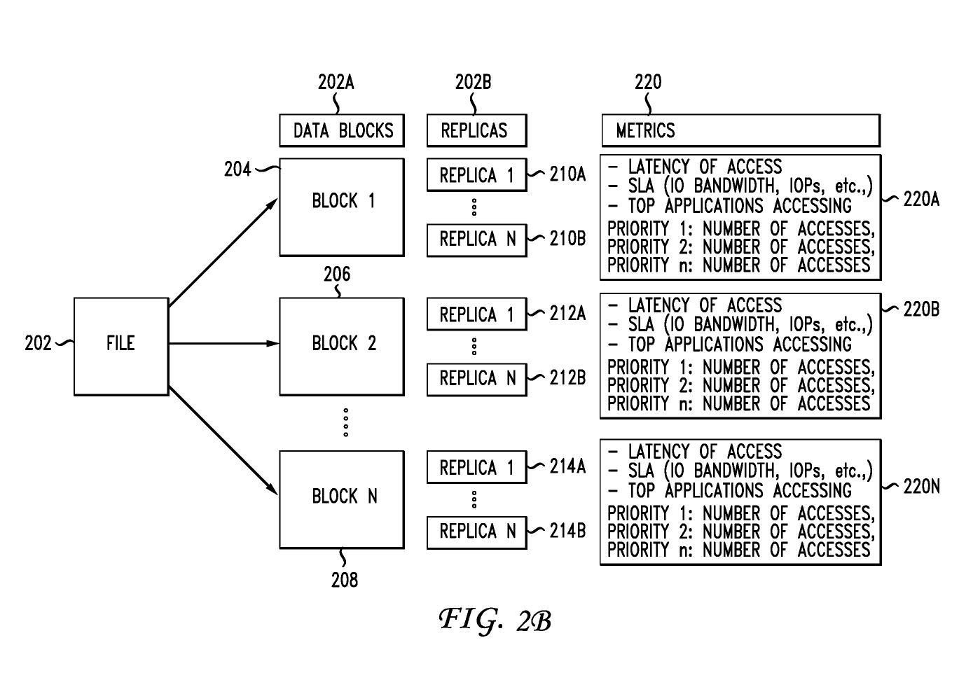

FIG. 2A illustrates a diagram of an example scheme 200 for splitting a file 202 into blocks 202A and generating replicas 202B for distributed storage. The file 202 can be “blocked” or split into blocks 202A of a specific block size (e.g., size ‘x’). For example, the file 202 can be split into blocks 204, 206, 208. Replicas 202B of blocks 204, 206, 208 can be created and stored on the network environment 100. For example, replicas 210A, 210N can be created for block 204, replicas 212A, 212N can be created for block 206, and replicas 214A, 214N can be created for block 208. The replicas 202B can then be used to reconstruct the file 202 based on a replica for each of the blocks 204, 206, 208. The replicas 202B can be increased/decreased for one or more of the blocks 204, 206, 208 to adjust the number and distribution of replicas 202B in the network environment 100, as further described herein.

Referring to FIG. 2B, metrics 220 can be collected and maintain for the replicas 202B for use by the controller 102 to manage replicas (e.g., add replicas, delete replicas, move replicas, etc.) and orchestrate replica access. The metrics 220 can include metrics 220A, 220B, 220N maintained for each of the blocks 202A and/or replicas 202B. For example, the controller 102 can collect and maintain metrics 220A for block 204, metrics 220B for block 206, and metrics 220N for block 208. The metrics 220A, 220B, 220N can thus provide statistics, access patterns, and status information for each respective block (204, 206, 208).

The metrics 220 of a block (e.g., 220A, 220B, 220N) can indicate, for example, a latency of access for the block, SLA information (e.g., IO bandwidth, IOPS, etc.), a number of applications that accessed the block over a period of time, the priorities of applications which accessed the block, the top n applications (as well as information about the applications such as priorities, requirements, etc.) that accessed the block over a period of time, an access count for each job or application priority (e.g., access count for priority 1, access count for priority 2, access count for priority n), a frequency of access for the block, a performance or status of one or more host nodes of the block (e.g., the storage nodes hosting the block), etc.

The metrics 220A, 220B, 220N can correspond to one or more of the replicas 202B (e.g., 210A, 210N, 212A, 212N, 214A, 214N). For example, the metrics 220 can include metrics for each individual replica and/or a combination of replicas. In some cases, the metrics 220A, 220B, 220N can correspond to the actual blocks 202A, including the replicas 202B of the blocks 202A. For example, the metrics 220A can include metrics for each individual replica 210A, 210N of block 204, as well as overall metrics for block 204 and/or the combination of replicas 210A, 210N. Thus, the metrics 220A can provide information about the block 204, including each of its replicas 210A, 210N, as well as respective information about each of the replicas 210A, 210N.

For example, the metrics 220A can indicate an access pattern for the overall block 204, including each of its replicas 210A, 210N, as well as an access pattern for each of the replicas 210A, 210N. This can provide insight into a pattern, status, performance, etc., of the block 204 as a whole, as well as an insight into the pattern, status, performance, etc., of each individual replica (210A, 210N) of that block.

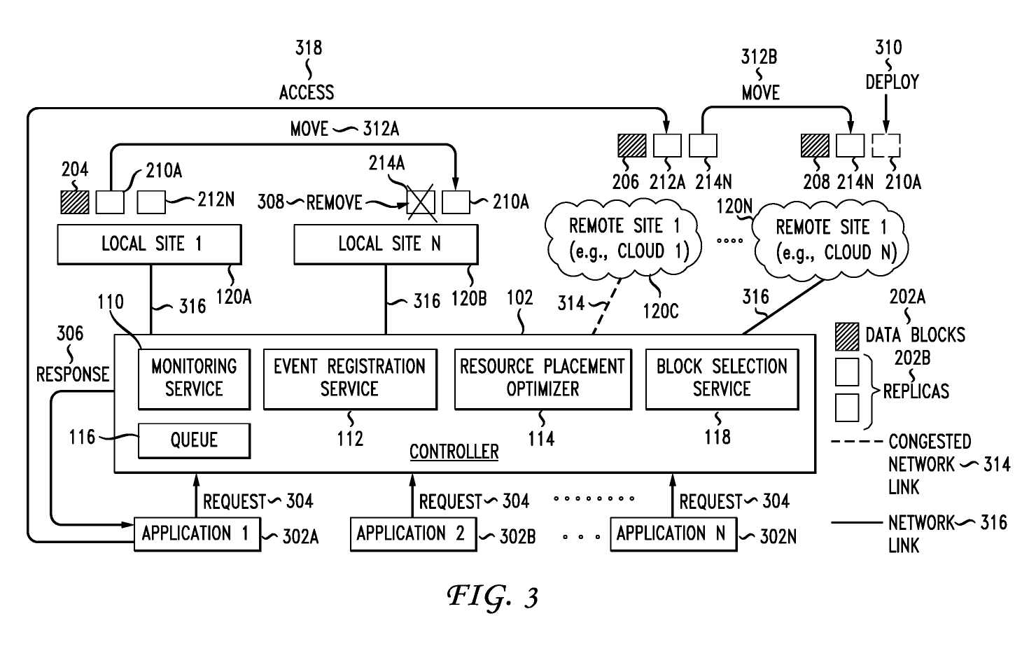

FIG. 3 illustrates an example flow of replica management and orchestration operations in the network environment 100. As illustrated, the controller 102 can communicate with the sites 120 to manage storage and access of blocks/replicas. The sites 120 can store the data blocks 202A and replicas 202B across the network environment 100. In some cases, the controller 102 can generate the data blocks 202A and/or replicas 202B for one or more files and select a storage site from the sites 120 for each of the data blocks 202A and/or replicas 202B.

For example, the controller 102 can split data of size ‘x’ into blocks of size ‘k’, generate a number n of replicas for each block, and distribute the replicas across the sites 120. To illustrate, the controller 102 can split a 1 MB file into 8 KB blocks, for a total of 125 blocks. The controller 102 can replicate and store each block across the network environment 100. For example, the controller 102 can generate 3 replicas of a block, and store 1 replica in local site 120A and 2 replicas in remote site 120C. The controller 102 can monitor the 3 replicas and adjust the number and/or distribution of replicas for the block based on collected metrics as described herein.

In FIG. 3, data block 204 is stored on local site 120A, data block 206 is stored on remote site 120C, and data block 208 is stored on remote site 120N. In addition, replica 210 is stored on local site 120A, replicas 210N, 214A are stored on local site 120B, replicas 212A, 214N are stored on remote site 120C, and replica 212N is stored on remote site 120N.

The controller 102 (e.g., via monitoring service 110) can monitor the sites 120, endpoints (e.g., storage nodes 130), and blocks (202A, 202B), register events (e.g., via event registration service 112) detected and maintain metrics for the blocks 202A, 202B. For each block, the metrics can include access patterns, performance statistics, application requirements, job priorities, status information, as well as any other statistics and/or metadata. The controller 102 can also monitor the links 314, 316 to the sites 120, maintain metrics for the links 314, 316, and detect whether a network link is congested (e.g., 314) or has a normal operating status (e.g., 316).

The controller 102 can continue to collect metrics (e.g., metrics 220) for each replica block and associate the metrics collected with the respective blocks/replicas. In some cases, the controller 102 can store collected metrics for a replica as metadata associated with the replica. For example, the controller 102 can store the following metadata for replica 210A: Replica 210A: Latency-of-Access=n ms; IO Bandwidth=m; IOPS=x; Access Count=y; Top Application Accessing Replica 210A=Application 1; Priority of Top Application=1; Access Count of Top Application=k; Second Top Application Accessing Replica 210A=Application 2; Priority of Second Top Application=2; Access Count of Second Top Application=z; Access Count by Access Type=n number of type x access (e.g., read, write, sequential, random, etc.), etc.

The controller 102 (e.g., via resource placement optimizer 114) can dynamically, proactively, and/or reactively adjust the number and/or distribution of replicas 202B based on current or predicted conditions, requirements, etc. The current or predicted conditions, requirements, etc., can be determined based on, for example, current events and collected statistics such as access patterns, job priorities, application requirements, network or device conditions, etc. The controller 102 can add, delete, move, etc., replicas 202B based on the current or predicted conditions, requirements, etc.

For example, the controller 102 can move (312A) replica 210A from local site 120A to local site 120B based on an access pattern associated with replica 210A, such as IOPS, sequential versus random access, read versus write access, etc. The controller 102 can detect a congested network link 314 to remote site 120C, and move (312B) replica 214N from remote site 120C to remote site 120N. The controller 102 can determine that one or more replicas of block 204 need to be added at remote site 120N to satisfy current and/or predicted conditions or requirements for block 204, and deploy (310) replica 210N of block 204 at remote site 120N.

The controller 102 can also remove (308) replica 214A from local site 120B based on access patterns, conditions, requirements, etc. For example, the controller 102 may determine that replica 214A has not been used or requested for a period of time, and subsequently remove it to lower cost and/or improve utilization (e.g., release space for other replicas with higher use frequency, reduce unnecessary storage use, increase available space, etc.). As another example, the controller 102 may determine that a priority associated with replica 214A (e.g., an average priority of jobs associated with replica 214A, a highest priority of jobs associated with replica 214A, etc.) is below a threshold (e.g., is low) and subsequently remove replica 214A from local site 120B to increase local or on-premises storage availability for potential use to store replicas associated with a higher priority. To illustrate, the controller 102 may determine that replica 214A can be removed from local site 120B, and delete the replica 214A to free space for the move (312A) of replica 210A to local site 120B.

When a job requests access to data in the network environment 100, the controller 102 can orchestrate access to the data for the job. The controller 102 can select each replica for the job based on one or more metrics (e.g., job SLA, access patterns, network conditions, storage node conditions, etc.) and identify a location for each selected replica which can be used to access the selected replica for the job.

For example, applications (or jobs) 302A, 302B, 302N (collectively “302”) can generate requests 304 for data. The requests 304 can include a job or application priority and/or any requirements for the job (e.g., latency, TO performance, SLA, etc.). The controller 102 can receive the requests 304 and add each pending request to the queue 116. The controller 102 can identify the blocks for the data requested and select specific replicas for the blocks based on the requests 304 (e.g., job or application priority, requirements, etc.), as well as metrics and conditions available to the controller 102 (e.g., access patterns, network conditions, storage node conditions, etc.). The controller 102 can provide a response to the application (or job) associated with the request, which can identify and/or locate each replica for the job.

For example, the controller 102 can receive a request 304 from application 302A for block 206. The controller 102 can select replica 212A on the remote site 120C for the request 304 from application 302A, and provide a response 306 to the application 302A identifying and/or locating replica 212A on the remote site 120C. The controller 102 can select replica 212A from the various replicas of block 206 (e.g., 212A, 212N) based on the priority or requirements of the request 304, the metrics (e.g., 220) collected for the replicas of block 206 (e.g., 212A, 212N), the conditions of the networks hosting the replicas of block 206 (e.g., remote site 120C which hosts replica 212A and local site 120A which hosts replica 212N), and/or the conditions of the links (e.g., 314, 316) of the sites hosting the replicas of block 206.

Based on the response 306, the application 302A can access (318) the replica 212A selected by the controller 102 for the request 304. The controller 102 can collect statistics for the request 304, response 306, and access 318 for future use. The controller 102 can add an access count for replica 212A, information about the application 302A and/or request 304 (e.g., job or application priority, job requirements, etc.), as well as any metadata about the response 306 and access 318, such as the access or response latency, the access type, the IOPS or access performance, the network performance, etc.

The controller 102 can continue monitoring data access patterns, response latencies, job properties, etc., perform replica placement and optimization operations, and intelligently matching replicas with jobs based on metrics and job requirements (e.g., SLA). The controller 102 can use the access patterns, performance statistics, and job requirements to dynamically orchestrate access of replicas and trigger adjustments in the distribution of replicas (202B) among the sites (e.g., sites 120) and storage types of the storage nodes 130 (e.g., HDD, SDD, Flash, etc).

The dynamic access and replica distribution decisions allow the controller 102 to proactively cater to application or job requirements (e.g., priority, performance, limits, etc.) and intelligently trigger replica access and distribution adjustments based on the metrics (replica access and site statistics, performance statistics, application requirements, etc.). In this way, the controller 102 can intelligently improve overall performance by tailoring replica access and distribution for jobs.

The controller 102 can define thresholds or triggers for adding, removing, moving, etc., replicas in the network environment 100. The thresholds or triggers can be limits, ranges, sensitivities, tolerances, etc., defined for one or more factors such as latency, bandwidth, TOPS, locality, architecture, network performance, cost, throughput, access counts, job priorities, access ratios, data distribution, etc. For example, the controller 102 can define a threshold latency of x maximum latency for a specific replica and/or job priority. If the controller 102 determines the threshold has been reached, the controller 102 can perform a replica placement optimization for the specific replica and/or any replicas associated with the specific replica. To illustrate, if the latency for replica 210A exceeds a threshold, the controller 102 can move the replica 210A to another location expected to yield a lower latency (e.g., a different storage node, a different type of storage, a different network or site, etc.) and/or deploy another replica corresponding to replica 210A at a different location (e.g., storage node, network or site, etc.).

For example, assume the local site 120A is an on-premises site and remote site 120C is a cloud site with higher latency than the local site 120A. Also assume that the controller receives a high-priority request from application 302B and a low-priority request from application 302N. For the high-priority request, the controller 102 can instruct application 302B to access a replica for the request from the on-premises site (e.g., local site 120A) instead of the cloud (e.g., remote site 120C), as the on-premises site is expected to have better network performance and yield a lower latency. By contrast, for the low-priority request, the controller 102 can instruct application 302N to access a replica for the request from the cloud (e.g., remote site 120C) as opposed to the on-premises site (e.g., local site 120A), in order to reduce the load from the on-premises site and/or prioritize access to the on-premises site to other requests (e.g., the high-priority request from application 302B).

Similarly, a replica having high access patterns or frequent requests from a high-priority application can be moved from a higher latency site, such as the cloud, to a lower latency site, such as on-premises, or can have additional replicas added to a site capable of increasing performance and/or improving distribution. The controller 102 can increase the performance for higher priority jobs by proactively adding replicas to a particular site (e.g., deploying extra replicas at on-premises sites) or adjusting replica access (e.g., directing requests to access local replicas rather than cloud replicas). For lower priority jobs, the controller 102 can proactively increase cloud replica access (which may lower cost and improve local replica access and distribution for higher priority jobs), decrease local replica access (which may lower cost and improve local replica access and distribution for higher priority jobs), or move/remove replicas from a particular site (e.g., move a local replica to the cloud or reduce a number of local replicas).

Thus, if a job has a high priority, the replicas having low latency, high bandwidth, or high IOPS can receive access preference for the job. In some cases, the controller 102 can also do an early fetch of replicas from the cloud (e.g., remote sites 120C or 120N). If the controller 102 determines that the jobs accessing a particular block are frequently (e.g., above a threshold frequency) of a high priority, the controller 102 can trigger more replicas of that particular block on faster storage nodes or types (e.g., SSD nodes) or locations that provide faster access (e.g., on-premises sites). Moreover, if a particular block of data on a local network or a fast storage node or type (e.g., an SSD node) has not received a threshold number of high priority access requests within a period of time, the particular block of data can be moved to the cloud or a slower storage node.

On the other hand, for lower priority jobs, the high latency or cheaper replicas can be selected for those jobs. Based on access patterns, if the frequency of jobs accessing the same data increases, replicas of that data can be provided and/or access to different storage nodes can be scheduled in order to improve performance.

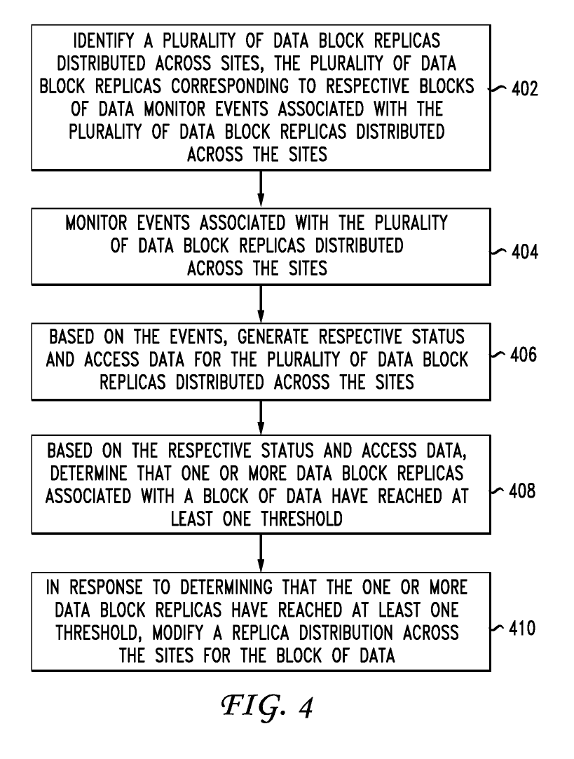

The disclosure now turns to FIG. 4, which illustrates a flowchart of an example method for managing replica access and distribution. The method is provided by way of example, as there are a variety of ways to carry out the method. Additionally, while the example method is illustrated with a particular order of blocks or steps, those of ordinary skill in the art will appreciate that the blocks in FIG. 4 can be executed in any order and the method can include fewer or more blocks than illustrated in FIG. 4.

At step 402, the controller 102 identifies a plurality of data block replicas (e.g., 202B) distributed across sites (e.g., sites 120 in network environment 100). The plurality of data block replicas correspond to respective blocks of data (e.g., 202A), such as a file. In some cases, the plurality of data block replicas can be stored across at least one local site (e.g., local site 120A and/or local site 120B) and at least one remote site (e.g., remote site 120C and/or remote site 120N).

The plurality of data block replicas can be stored across different storage devices or components (e.g., storage nodes 130) on the sites. For example, a first portion of the plurality of data block replicas can be stored on one or more HDDs at an on-premises site (e.g., at local site 120A and/or local site 120B) and a second portion of the plurality of data block replicas can be stored on one or more SSDs at the on-premises site, while a third portion of the plurality of data block replicas can be stored on one or more storage nodes or resources on the cloud (e.g., remote site 120C and/or remote site 120N). Thus, the plurality of data blocks across the site can have different locality attributes, network attributes (e.g., latency, throughput or bandwidth, etc.), access attributes (e.g., IOPS, IO latency, IO bandwidth, etc.), etc.

At step 404, the controller 102 monitors events associated with the plurality of data block replicas distributed across the sites. The events can include, for example, access events, network events, application events, jobs, errors, requests, storage events, workload events, etc. Based on the events, at step 406, the controller 102 generates respective status and access data (e.g., metrics 220) for the plurality of data block replicas distributed across the sites. The respective status and access data can include, for example, access patterns, network status information, device status information, event information, storage information, SLA information, access and/or performance statistics, etc.

Based on the respective status and access data, at step 408, the controller 102 determines that one or more data block replicas associated with one or more blocks of data (e.g., replica 210A associated with block 204, replica 210B associated with block 204, etc.) have reached at least one threshold. The threshold can be a data access threshold(s). The data access threshold can be, for example, a threshold latency, a threshold IOPS, a threshold network congestion, a threshold number of requests (e.g., application or data requests, jobs, etc.), a threshold number of requests exceeding a priority (e.g., a number of requests having an application priority above x), a threshold availability, a threshold ratio of replicas and/or requests, a threshold data access count (e.g., overall access count and/or an access count for one or more specific data access types), a threshold number or type of errors, etc.

The threshold can include multiple values. The multiple values can include a single value for multiple parameters, multiple values for a single parameter, multiple values for multiple parameters, or a combination thereof. For example, the threshold can include multiple values for a particular parameter, indicating an acceptable range for the particular parameter, such as a maximum (e.g., maximum tolerance) for the particular parameter (e.g., access counts) and a minimum (e.g., minimum tolerance) for the particular parameter. As another example, the threshold can include multiple values for one or more parameters, such as tolerance range for latency, a maximum and/or minimum access count, a number of application requests having a job priority of x, etc.

In response to determining that the one or more data block replicas have reached at least one threshold, at step 410, the controller 102 modifies a replica distribution across the sites for the one or more blocks of data. The at least one threshold can be configured to trigger the modification of replica distribution. For example, the controller 102 can monitor the plurality of data block replicas and trigger a modification of replica distribution for one or more data block replicas when the controller 102 detects that one or more associated thresholds have been met.

The modification of replica distribution can include adjusting the number and/or placement of replicas for one or more blocks. For example, the modification of replica distribution can include adding one or more replicas, removing one or more replicas, moving one or more replicas, etc. Replicas can be added, removed, moved, etc., based on the respective status and access data. For example, replicas can be added, removed, moved, etc., based on access patterns in the respective status and access data, performance statistics from the respective status and access data, job requirements (e.g., priorities, access demands, etc.) from the respective status and access data, network and/or device conditions from the respective status and access data, etc. Thus, replicas can be adjusted across the distributed environment to account for data and application requirements, data and network status and performance, etc.

The dynamic adjustment of replicas can optimize utilization and performance. For example, when making distribution and placement decisions, networks and/or resources expected to yield a higher performance can be given preference for storing replicas associated with higher job priorities or data access demands, and networks and/or resources expected to yield a lower performance can be given preference for storing replicas associated with lower job priorities or data access demands.

The controller 102 can also intelligently manage data access across the sites. For example, the controller 102 can receive requests for data blocks and select specific replicas for the requested data blocks based on various factors, such as job requirements, replica performance, network performance, access patterns, etc. The controller 102 can orchestrate access to the selected replicas for requesting jobs to optimize performance and/or utilization.

For example, the controller 102 can receive a high priority job from an application and a low priority job from another application. Each job can request one or more blocks of data. The controller 102 can identify the blocks requested and select a specific replica in the distributed environment for each requested block based on the priorities and metrics collected by the controller 102. In this example, for the high priority job, the controller 102 can orchestrate access to replicas associated with a low latency and/or high performance, such as on-premises replicas. For the low priority job, the controller 102 can orchestrate access to replicas associated with a higher latency and/or lower performance, such as replicas on the cloud.

As another example, assume the controller 102 determines that a replica has been accessed or requested at a low frequency and another replica has been accessed or requested at a high frequency. The controller 102 can move the replica associated with the low frequency to the cloud or remove an instance of the replica from one or more locations (e.g., slower or cheaper storage locations or devices), while moving the replica associated with the high frequency or adding an instance of the replica to one or more locations, such as a location or device having higher cost or performance, all while maintaining minimum number of replicas for each block to ensure availability.

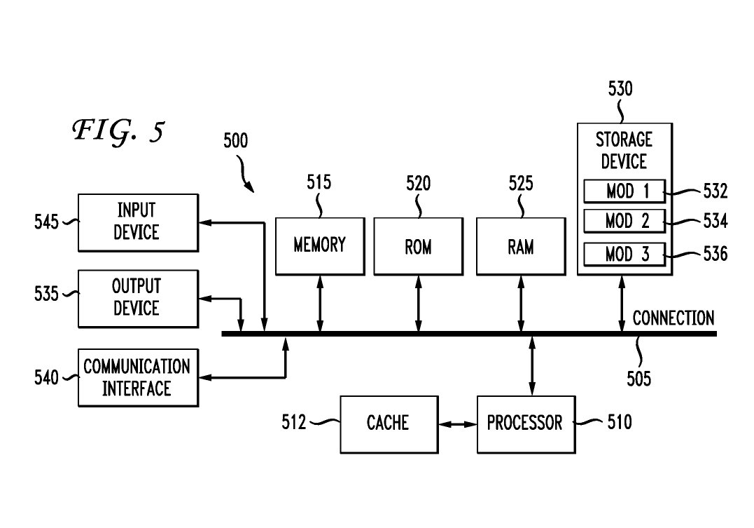

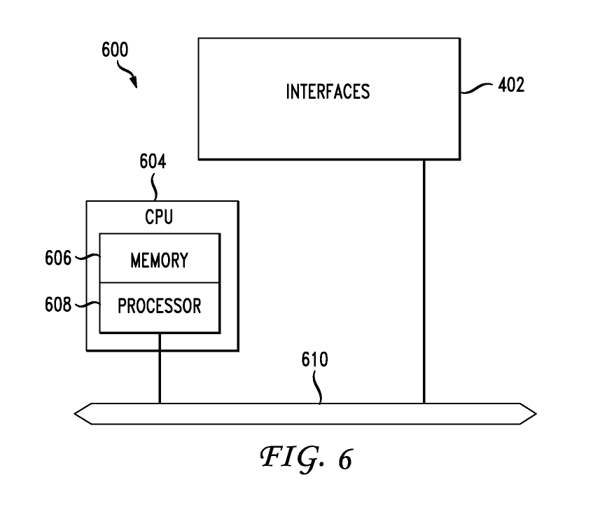

The disclosure now turns to FIGS. 5 and 6, which illustrate example computing and network devices, such as switches, routers, load balancers, servers, client computers, and so forth.

FIG. 5 illustrates an example architecture for a computing system 500. Computing system 500 can include central processing unit (CPU) 510 and system connection 505 (e.g., BUS) that may couple various system components including system memory 515, memory (ROM) 520, and random access memory (RAM) 525, to CPU 510. Computing system 500 can include cache 512 of high-speed memory connected directly with, in close proximity to, or integrated as part of CPU 510. Computing system 500 can copy data from memory 515 and/or storage device 530 to cache 512 for quick access by CPU 510. In this way, cache 512 can provide a performance boost that avoids processor delays while waiting for data. These and other modules can control CPU 510 to perform various actions. Other system memory may be available for use as well. Memory 515 can include multiple different types of memory with different performance characteristics. CPU 510 can include any general purpose processor and a hardware module or software module configured to control CPU 510 as well as a special-purpose processor where software instructions are incorporated into the actual processor design. CPU 510 may essentially be a completely self-contained computing system, containing multiple cores or processors, a bus, memory controller, cache, etc. A multi-core processor may be symmetric or asymmetric.

To enable user interaction with computing system 500, input device 545 can represent any number of input mechanisms, such as a microphone for speech, a touch-protected screen for gesture or graphical input, keyboard, mouse, motion input, speech and so forth. Output device 535 can also be one or more of a number of output mechanisms known to those of skill in the art. In some instances, multimodal systems can enable a user to provide multiple types of input to communicate with computing system 500. Communications interface 540 can govern and manage the user input and system output. There may be no restriction on operating on any particular hardware arrangement and therefore the basic features here may easily be substituted for improved hardware or firmware arrangements as they are developed.

Storage device 530 can be a non-volatile memory and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and hybrids thereof. Storage device 530 can include software modules 532, 534, 536 for controlling CPU 510.

In some embodiments, a computing system that performs a particular function can include the software component stored in a computer-readable medium in connection with the necessary hardware components, such as CPU 510, connection 505, output device 535, and so forth, to carry out the function.

One of ordinary skill in the art will appreciate that computing system 500 can have more than one processor 510 or can be part of a group or cluster of computing devices networked together to provide greater processing capability.

FIG. 6 illustrates an example network device 600 suitable for performing switching, routing, assurance, and other networking operations. Network device 600 includes a central processing unit (CPU) 604, interfaces 602, and a connection 610 (e.g., a PCI bus). When acting under the control of appropriate software or firmware, the CPU 604 is responsible for executing packet management, error detection, and/or routing functions. The CPU 604 preferably accomplishes all these functions under the control of software including an operating system and any appropriate applications software. CPU 604 may include one or more processors 606, such as a processor from the INTEL X66 family of microprocessors. In some cases, processor 606 can be specially designed hardware for controlling the operations of network device 600. In some cases, a memory 606 (e.g., non-volatile RAM, ROM, TCAM, etc.) also forms part of CPU 604. However, there are many different ways in which memory could be coupled to the system. In some cases, the network device 600 can include a memory and/or storage hardware, such as TCAM, separate from CPU 604. Such memory and/or storage hardware can be coupled with the network device 600 and its components via, for example, connection 610.

The interfaces 602 are typically provided as modular interface cards (sometimes referred to as “line cards”). Generally, they control the sending and receiving of data packets over the network and sometimes support other peripherals used with the network device 600. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communications intensive tasks, these interfaces allow the master microprocessor 604 to efficiently perform routing computations, network diagnostics, security functions, etc.

Although the system shown in FIG. 6 is one specific network device of the present disclosure, it is by no means the only network device architecture on which the concepts herein can be implemented. For example, an architecture having a single processor that handles communications as well as routing computations, etc., can be used. Further, other types of interfaces and media could also be used with the network device 600.

Regardless of the network device's configuration, it may employ one or more memories or memory modules (including memory 606) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 606 could also hold various software containers and virtualized execution environments and data.

The network device 600 can also include an application-specific integrated circuit (ASIC), which can be configured to perform routing, switching, and/or other operations. The ASIC can communicate with other components in the network device 600 via the connection 610, to exchange data and signals and coordinate various types of operations by the network device 600, such as routing, switching, and/or data storage operations, for example.

For clarity of explanation, in some instances the various embodiments may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described embodiment can reside within computer-executable instructions stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media used to store instructions, information used, and/or information created during methods according to described examples can include magnetic or optical disks, flash memory, USB devices provided with non-volatile memory, networked storage devices, and so on.

Devices implementing methods according to the present disclosure can comprise hardware, firmware, and/or software, and can take any of a variety of form factors. Typical examples of such form factors include laptops, smart phones, small form factor personal computers, personal digital assistants, rack-mount devices, standalone devices, and so on. Functionality described in the present disclosure can also reside in peripherals or add-in cards. Such functionality can also reside on a circuit board among different chips or different processes executing in a single device, by way of further example. The instructions, media for conveying such instructions, computing resources for executing them, and other structures for supporting such computing resources are means for providing the functions described in these disclosures.

Although a variety of examples and other information explain aspects within the scope of the appended claims, one of ordinary skill will understand not to imply any limitation based on particular features or arrangements in such examples, as one of ordinary skill would be able to use these examples to derive a wide variety of implementations. Further and although the present disclosure may describe some subject matter in language specific to examples of structural features and/or method steps, one of ordinary skill will understand that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B (i.e., one or more of A, one or more of B, or one or more of A and B). Moreover, claim language reciting “one or more of A and B” means A, B, or A and B (i.e., one or more of A, one or more of B, or one or more of A and B).

What is claimed is:

1. A method comprising:
identifying a plurality of data block replicas distributed across sites, the plurality of data block replicas corresponding to respective blocks of data;
monitoring events associated with the plurality of data block replicas distributed across the sites;
based on the events, generating respective status and access data for the plurality of data block replicas distributed across the sites;
based on the respective status and access data, determining that one or more data block replicas associated with a block of data have reached at least one data access threshold; and
in response to determining that the one or more data block replicas have reached at least one data access threshold, modifying a replica distribution across the sites for the block of data.

2. The method of claim 1, further comprising:
receiving a request from an application for the block of data, the request comprising one or more requirements associated with the application;
based on the one or more requirements, selecting a particular data block replica from the replica distribution across the sites for the block of data; and
orchestrating access by the application to the particular data block replica from a respective network resource storing the particular data block replica, the respective network resource being located at one of the sites.

3. The method of claim 2, wherein selecting the particular data block replica comprises:
identifying respective data block replicas in the replica distribution across the sites, the respective data block replicas corresponding to the block of data;
based on the respective status and access data, determining a respective status and access pattern for each of the respective data block replicas;
determining that the particular data block replica satisfies the one or more requirements based on the respective status and access pattern associated with the particular data block replica; and
in response to determining that the particular data block replica satisfies the one or more requirements, selecting the particular data block replica from the respective data block replicas.

4. The method of claim 1, wherein the respective status and access data for the plurality of data block replicas distributed across the sites comprises data access statistics, the data access statistics comprising at least one of:
a respective data access count; and
respective data access priorities associated with the respective data access count.

5. The method of claim 4, wherein the respective data access count comprises at least one of a total access count, a current access count, a sequential data access count, a random access count, a read count, and a write count.

6. The method of claim 4, wherein the respective data access priorities are based on at least one of a respective application priority or a respective application type corresponding to each application associated with a data access in the respective data access count, and wherein the data access statistics comprise a respective data access priority count for each of the respective data access priorities.

7. The method of claim 4, wherein the sites comprise at least one local network and at least one remote network, wherein the at least one data access threshold comprises at least one of a latency tolerance, an input/output performance tolerance, a network congestion limit, an access count limit, an access type count limit, a data access priority count limit, an access frequency limit, and an application priority requirement.

8. The method of claim 7, wherein the at least one remote site comprises a cloud and wherein the at least one data access threshold comprises a trigger for modifying the replica distribution across the sites.

9. The method of claim 8, wherein modifying the replica distribution across the sites comprises at least one of adding a replica to one or more locations, removing the replica from one or more locations, or moving the replica to one or more locations, the one or more locations comprising at least one of a network or a storage node.

10. The method of claim 9, wherein the one or more locations are selected based on a storage type, a storage performance, a network performance, and a job priority.

11. A system comprising:
one or more processors; and
at least one computer-readable storage medium including instructions that, when executed by the one or more processors, cause the system to:
identify a plurality of data block replicas distributed across sites, the plurality of data block replicas corresponding to respective blocks of data;
monitor events associated with the plurality of data block replicas distributed across the sites;
based on the events, generate respective status and access data for the plurality of data block replicas distributed across the networks;
based on the respective status and access data, determine that one or more data block replicas associated with a block of data have reached at least one data access threshold; and
in response to determining that the one or more data block replicas have reached at least one data access threshold, modify a replica distribution across the sites for the block of data.

12. The system of claim 11, the at least one computer-readable storage medium including instructions that, when executed by the one or more processors, cause the system to:
receive a request from an application for the block of data, the request comprising one or more requirements associated with the application;
based on the one or more requirements, select a particular data block replica from the replica distribution across the networks for the block of data; and
orchestrate access by the application to the particular data block replica from a respective network resource storing the particular data block replica, the respective network resource being located at one of the sites.

13. The system of claim 12, wherein selecting the particular data block replica comprises:
identifying respective data block replicas in the replica distribution across the sites, the respective data block replicas corresponding to the block of data;
based on the respective status and access data, determining a respective status and access pattern for each of the respective data block replicas;
determining that the particular data block replica satisfies the one or more requirements based on the respective status and access pattern associated with the application; and
in response to determining that the particular data block replica satisfies the one or more requirements, selecting the particular data block replica from the respective data block replicas.

14. The system of claim 11, wherein the respective status and access data for the plurality of data block replicas distributed across the networks comprises data access statistics, the data access statistics comprising at least one of:
a respective data access count; and
respective data access priorities associated with the respective data access count.

15. The system of claim 14, wherein the respective data access count comprises at least one of a total access count, a current access count, a sequential data access count, a random access count, a read count, and a write count, wherein the sites comprise at least one local site and at least one remote site, wherein the at least one data access threshold comprises at least one of a latency tolerance, an input/output performance tolerance, a network congestion limit, an access count limit, an access type count limit, a data access priority count limit, an access frequency limit, and an application priority requirement.

16. The system of claim 15, wherein the at least one remote site comprises a cloud and wherein the at least one data access threshold comprises a trigger for modifying the replica distribution across the sites, wherein modifying the replica distribution across the sites comprises at least one of adding a replica to one or more sites, removing the replica from one or more sites, or moving the replica to one or more sites.

17. A non-transitory computer-readable medium comprising:
one or more processors; and
instructions stored thereon which, when executed by the one or more processors, cause the one or more processors to:
identify a plurality of data block replicas distributed across sites, the plurality of data block replicas corresponding to respective blocks of data;
monitor events associated with the plurality of data block replicas distributed across the sites;
based on the events, generate respective status and access data for the plurality of data block replicas distributed across the sites;
based on the respective status and access data, determine that one or more data block replicas associated with a block of data have reached at least one data access threshold; and
in response to determining that the one or more data block replicas have reached at least one data access threshold, modify a replica distribution across the sites for the block of data.

18. The non-transitory computer-readable medium of claim 17, storing instructions that, when executed by the one or more processors, cause the one or more processors to:
receive a request from an application for the block of data, the request comprising one or more requirements associated with the application;
based on the one or more requirements, select a particular data block replica from the replica distribution across the sites for the block of data; and
identify the particular data block replica selected in a response to the request from the application.

19. The non-transitory computer-readable medium of claim 17, wherein the respective status and access data for the plurality of data block replicas distributed across the sites comprises data access statistics and application priority statistics, wherein the sites comprise at least one local site and at least one remote site.

20. The non-transitory computer-readable medium of claim 17, wherein the at least one data access threshold comprises at least one of a latency, an input/output performance, a network congestion, an access count, an access type count, a data access priority count, an access frequency, and an application priority requirement, the at least one data access threshold triggering the modifying of the replica distribution across the sites, and wherein modifying the replica distribution comprises at least one of adding a replica to one or more locations, removing the replica from one or more locations, or moving the replica to one or more locations, the one or more locations comprising at least one of a network or a storage node selected based on a type, a performance, and a job priority.
